(19) United States
(12) Patent Application Publication
(10) Pub. No.: US 2026/0275197 A1
(43) Pub. Date: Sep. 17, 2026

(54) HYDROPHOBIC LIGNIN-BASED IN-BUILT FIRE RETARDANT, ITS PREPARATION AND APPLICATION IN POLYURETHANE FOAM

(71) Applicant: Nano and Advanced Materials Institute Limited, Hong Kong (HK)

(72) Inventors: Su Ping BAO, Hong Kong (HK); Xin XING, Hong Kong (HK); Lei GAO, Hong Kong (HK)

(21) Appl. No.: 19/080,973

(22) Filed: Mar. 17, 2025

(51) Int. Cl. C09K 21/12; C08J 9/00

(52) U.S. Cl. CPC C09K 21/12; C08J 9/0023; C08J 9/0038; C08J 9/0095; C08J 2205/042; C08J 2205/052; C08J 2205/10

(57) ABSTRACT

The present invention provides a simple fabrication process with (no acid, no solvent, halogen-free) environmental-friendly steps to produce a lignin-based fire retardant (LFR) material with in-built fire-retardant functional groups for polyurethane (PU) foam. It also involves the chemical reaction for activating lignin by grafting nonhalogenated phosphate groups of traditional fire retardant with reactive functional groups and changing the original hydrophilic property of traditional fire retardant to hydrophobic property of the novel LFR. A bio-based PU foam with inbuilt fire retardancy is designed by the application of the LFR. The good fire retardancy of the developed PU foam can be achieved without affecting density or compromising thermal conductivity.

### FIELD OF THE INVENTION

The present invention generally relates to the field of fire retardant with bio-based lignin resources, processes for preparing them, and their application in polyurethane foams.

### BACKGROUND OF THE INVENTION

Polyurethane (PU) foam, particularly rigid foam, is widely used in the construction industry for thermal insulation due to its excellent insulating properties and lightweight nature. However, a significant drawback of PU foam is its high flammability and its limiting oxygen index (LOI) is very low to be under 20 percent so that it is extremely easy to ignite in air, which poses substantial fire safety risks in building applications. There is an urgent need for effective fire-retardant solutions to improve the safety of these materials.

To mitigate flammability, manufacturers often incorporate large quantities of fire-retardant additives, which sometimes are up to 50% of the formulation. Traditional methods typically involve the use of halogenated fire retardants, which, while effective, raise environmental and health concerns due to their toxic nature. Recent advancements have introduced new inorganic fire retardants; however, these are often incompatible with PU systems, increasing the viscosity of the foam during production and complicating the manufacturing process. Additionally, many inorganic fire retardants are hydrophilic, leading to moisture absorption that compromises the integrity of the PU foam. Given the limitations of existing fire-retardant solutions, there is a critical need to develop a fire retardant that provides inherent fire resistance within the PU matrix without compromising the overall performance of PU foam.

Lignin, a natural polymer derived from the cell walls of plants and primarily produced as a byproduct of the pulp and paper industry, offers a promising alternative for enhancing the fire resistance of PU foams. Its inherent char-forming properties can contribute to fire retardancy, making it an attractive candidate for incorporation into foam formulations. Despite its potential, the application of lignin in PU foams is currently limited. Challenges include achieving optimal dispersion and compatibility within the foam matrix. Non-uniform distribution of natural lignin, particularly when it lacks compatible functional groups, can lead to agglomeration within the foam, negatively impacting mechanical properties and overall performance of the PU foam.

Addressing these challenges is essential to unlock lignin's full potential as a viable fire retardant in PU formulations. One promising approach is to modify this natural material to facilitate its integration into the crosslinking of PU foam, enhancing both compatibility and performance.

CN U.S. Pat. No. 103910850A disclosed a fire-retardant and reinforced PU rigid foam along with their preparation method. The PU foam achieves fire retardancy through phosphating-modified lignin, leveraging the phosphoric acid system in the modification liquid and the inherent aromatic heterocyclic structure of lignin. Additionally, the foam is strengthened by incorporating modified polyhydroxy lignin. However, this invention involves modifying the lignin with an alkaline formaldehyde solution as a solvent followed by a heating reaction. The solvent is highly toxic and environmentally harmful.

US20230025729A1 provided a process for making a modified lignin product in a Mannich reaction in which a lignin source and a nitrogen source are heated in a starved concentration of a C₁-C₅ aldehyde, preferably formaldehyde, in the presence of an acidic or basic catalyst. However, they can integrate up to 60 wt. % of the modified lignin to rigid foam to demonstrate outstanding fire retardancy, the modification process involving a C₁-C₅ aldehyde is not environmentally friendly.

CN U.S. Pat. No. 112266463A discloses a fire-retardant lignin-based PU rigid foam designed for automotive interior applications, along with its manufacturing process. They fabricated the lignin-based PU rigid foam with good flame retardance and mechanical property, few volatile harmful substances and easy degradation. They fabricated the lignin-modified polyether polyols by reacting lignin with a solid acid catalyst and an alcoholization agent, followed by a reaction involving trichloromethane and trichlorophosphorus to produce fire-retardant lignin-based polyether polyols. The process involves the use of significant amounts of halogenated solvents and materials.

Prior patent applications have investigated modified lignin products for diverse applications, including fire-retardant PU foams. Although these advancements have demonstrated potential in improving fire resistance, they also present significant limitations. For instance, most prior art require the alcoholization of lignin and its combination with other polyols as a fundamental raw material for PU foams. This procedure involves the liquefaction and activation of lignin, typically using strong acids as catalysts and organic solvents. Unfortunately, these catalysts and solvents are often hazardous and contribute to environmental pollution.

Consequently, there is a significant need for lignin-based materials with inherent fire-retardant properties and a simplified fabrication process that eliminates the use of acid, solvents, and halogens, promoting a more environmentally sustainable approach.

### SUMMARY OF THE INVENTION

The object of this invention is to integrate the lignin with fire retardant functional groups directly using environmental-friendly steps. This eliminates the need for traditional alcoholization and harmful catalysts. Unlike conventional methods that use lignin solely as a polyol, this approach grafts fire-retardant groups onto lignin while combining it with an isocyanate prepolymer. This innovation not only enhances the fire-retardant performance of PU rigid foam without compromising its density or thermal conductivity but also maximizes the structural benefits of lignin. Furthermore, by utilizing lignin as a bio-based raw material, this method increases the bio-content of PU foam, offering a sustainable, high-performance solution that improves both safety and environmental impact.

In one aspect, the present invention provides a hydrophobic lignin-based in-built fire retardant, which includes a lignin source, an isocyanate component, and a phosphorous source. The lignin source is modified by reacting with the isocyanate component prior to reaction with the phosphorous source, forming a stable cross-linked network. The hydrophobic lignin-based in-built fire retardant comprises in-built fire-retardant functional groups chemically bonded to the lignin source and exhibits a hydrophobic surface with a water contact angle greater than 120 degrees.

In one embodiment, the lignin source includes lignosulfonic acid sodium salt, lignosulfonic acid calcium salt, or alkali lignin.

In one embodiment, the isocyanate component includes polymethylene polyphenyl polyisocyanate, e.g., PM200, PM400 or diphenylmethane diisocyanate, e.g., MDI-50, MDI-100, MDI-100L.

In one embodiment, the phosphorous source includes 9,10-dihydro-9-oxa-10-phosphaphenanthrene-10-oxide (DOPO).

In one embodiment, the fire retardant is in powder form, having a homogeneous particle size distribution of less than 0.074 mm.

In one embodiment, the in-built fire-retardant functional groups contribute to a limiting oxygen index (LOI) of at least 26.4% without varying the foam thermal conductivity when incorporated into the polyurethane foams.

In one embodiment, the hydrophobic lignin-based in-built fire retardant prevents water absorption, thereby maintaining thermal insulation and fire resistance performance of the hydrophobic lignin-based in-built fire retardant over time.

In one embodiment, the hydrophobic lignin-based in-built fire retardant is free from the use of acids, solvents, or halogens.

In another aspect, the present invention provides a method for preparing a hydrophobic lignin-based in-built fire retardant, including reacting a lignin source with an isocyanate component in a reaction system at a temperature of approximately 90° C. for 30 to 90 minutes under nitrogen gas conditions; adding a phosphorous source into the reaction system and raising the temperature to approximately 120° C. and stirring for 10 to 20 minutes to form a solid product; drying the solid product at a temperature greater than 70° C. for 15 hours; and crushing the solid product into a powder and sieving it to obtain a homogeneous particle size distribution. The method is conducted in the absence of acids, solvents, and halogens.

In one embodiment, the lignin source includes lignosulfonic acid sodium salt, lignosulfonic acid calcium salt, or alkali lignin; the isocyanate component includes polymethylene polyphenyl polyisocyanate (e.g., PM200, PM400), diphenylmethane diisocyanate (e.g., MDI-50, MDI-100, MDI-100L), or a combination thereof; and the phosphorous source includes DOPO.

In one embodiment, the lignin source is grafted with isocyanate groups from diphenylmethane diisocyanate and non-halogenated phosphate groups from a traditional fire retardant, incorporating reactive functional groups, thereby converting original hydrophilic properties of the traditional fire retardant into hydrophobic properties.

In another aspect, the present invention provides a polyurethane rigid foam with in-built fire retardancy. The polyurethane rigid foam includes a formulation of:
10-90 parts of bio-based polyol;
10-90 parts of non bio-based polyol;
3 parts of blowing agent;
2-3 parts of foam stabilizer;
0.5-3 parts of catalyst;
0.1-30 parts of fire retardant fillers;
1-10 parts of hydrophobic lignin-based in-built fire retardant of claim 1; and
130-160 parts of isocyanate component.

The polyurethane rigid foam has enhanced fire resistance, and the polyurethane rigid foam exhibits a hydrophobic surface with a water contact angle greater than 120 degrees.

In one embodiment, the bio-based polyol is selected from bio-based polyol derived from cashew nut shell oil (e.g., FX9001, FX9001LV, and FX9011), or caster polyol; and the non bio-based polyol is selected from polyether polyols, e.g., polyether 403, polyether 4110, polyether 330N.

In one embodiment, the catalyst includes amine catalyst, e.g., N,N-dicyclohexylmethylamine or triethylenediamine, and dibutyltin dilaurate.

In one embodiment, the blowing agent includes water.

In one embodiment, the isocyanate component includes polymethylene polyphenyl polyisocyanate (e.g., PM200, PM400), diphenylmethane diisocyanate (e.g., MDI-50, MDI-100, MDI-100L), or a combination thereof.

In one embodiment, the foam stabilizer includes silicone surfactant, polyether polydimethylsiloxane copolymer, organosilicone copolymer.

In one embodiment, the fire retardant fillers include expanded graphite, and dimethyl methylphosphonate.

In one embodiment, the polyurethane rigid foam exhibits a limiting oxygen index (LOI) of at least 26.4%.

In one embodiment, the polyurethane rigid foam exhibits a closed-cell structure with a cell size distribution ranging from 50 to 500 microns.

In yet another aspect, the present invention provides a method of producing a fire-resistant PU rigid foam, including mixing a polyol component, the LFR, a catalyst, a foam stabilizer, and a blowing agent; adding an isocyanate component; agitating the mixture at 2000 to 5000 rpm; molding the mixture for foaming; curing the molded foam at 60-80° C.; and demolding the fire-resistant polyurethane rigid foam.

In one embodiment, the fire retardant is added in an amount of at least 10 parts per 100 parts of the polyol component.

In one embodiment, the isocyanate component includes polymethylene polyphenyl polyisocyanate (e.g., PM200, PM400), diphenylmethane diisocyanate (e.g., MDI-50, MDI-100, MDI-100L), or a combination thereof.

In one embodiment, the PU foam exhibits a LOI of at least 26.4%.

In one embodiment, the PU foam exhibits a water contact angle of at least 120 degrees, demonstrating hydrophobicity. In one embodiment, the density of the PU foam is maintained at approximately 44 kg/m³, and the thermal conductivity of the foam is maintained at approximately 0.024 W/(m·K), which is comparable to conventional PU foam.

This invention addresses these shortcomings of traditional PU foam materials and their associated fire retardant solutions. Specifically, it overcomes the high flammability of PU foam, which typically has a low LOI of less than 20%, making it highly susceptible to ignition and posing safety risks. Additionally, this invention provides a more environmentally friendly and effective alternative to conventional flame retardants, which often pose environmental and processing challenges. Traditional halogenated flame retardants, although effective, are toxic to the environment, while inorganic flame retardants tend to be incompatible with PU systems, increasing foam viscosity and negatively affecting processing performance. Furthermore, conventional lignin-based fire retardant modification techniques, such as phosphating or Mannich reactions, typically require the use of acids, solvents, or formaldehyde, which are harmful to the environment and can compromise PU performance. Finally, the invention resolves the compatibility issues between lignin and PU foam, improving the dispersion of natural lignin, which is prone to aggregation, thereby enhancing the mechanical properties of the foam.

### BRIEF DESCRIPTION OF THE DRAWINGS

Embodiments of the invention are described in more details hereinafter with reference to the drawings, in which:

FIG. 1 shows a chemical structure of lignin-based fire retardant (LFR);

FIG. 2 shows a fabrication process of the modified hydrophobic lignin with in-built fire retardant functional groups;

FIG. 3 shows plots the Fourier-transform infrared (FTIR) curves of lignin, MDI, DOPO and LFR; and

FIG. 4 shows the hydrophilic property of lignin and the hydrophobic property of LFR.

### DETAILED DESCRIPTION

The lignin source used in the invention is a bio-based polymer commonly found in plant cell walls. It serves as the backbone of the LFR and is modified to enhance its fire-retardant properties. Suitable lignin sources include lignosulfonic acid sodium salt, lignosulfonic acid calcium salt, or alkali lignin. These lignin variants are chemically reactive and can be further functionalized to achieve better compatibility with PU formulations.

The isocyanate component used in the invention plays a critical role in the preparation of the LFR by crosslinking lignin and facilitating the bonding of fire-retardant functional groups. Isocyanates, which contain highly reactive —N═C═O functional groups, ensure strong chemical integration between lignin and the added fire-retardant components.

The phosphorous source is utilized in the chemical modification of lignin. This phosphorous compound enhances the flame-retardant properties of the LFR by contributing to char formation and reducing flammability.

The in-built fire-retardant functional groups used in the invention contribute to the overall fire retardancy of the material by increasing the limiting oxygen index (LOI), a critical parameter for assessing flame resistance. Unlike conventional fire-retardant additives that are mixed into polymer formulations and may degrade over time, these functional groups remain permanently attached to the lignin, ensuring stable and long-lasting fire resistance.

The limiting oxygen index (LOI), which measures the minimum oxygen concentration required to sustain combustion. Materials with higher LOI values exhibit better fire resistance. In this invention, PU foams modified with the LFR achieve an LOI of at least 26.4%, which is significantly higher than that of conventional PU foams. This improvement ensures enhanced fire safety without compromising other critical properties such as density and thermal conductivity.

In the following description, lignin-based hydrophobic fire retardant, preparation method thereof, and application thereof in PU rigid foams are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The present invention includes the formation of a LFR with the reaction mechanism, preparing processes, and its application in PU rigid foams.

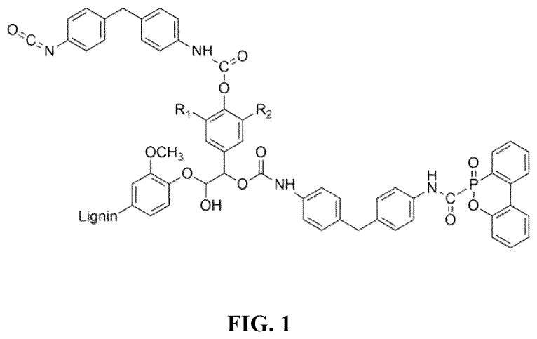

Lignin, as a bio-based raw material, is built into the fire retardant. FIG. 1 shows chemical structure of the LFR. R₁ or R₂ is selected from H or OCH₃. The designed chemical structures make it possible to integrate inbuilt fire retardancy directly into the materials themselves.

The environmentally friendly LFR offers significant advantages over existing technology:

First, it provides an environmentally friendly manufacturing process that does not use acids, solvents, or halogens, thus avoiding environmental pollution. The invention utilizes MDI to activate lignin and introduces flame-retardant functional groups through DOPO, directly imparting built-in fire retardant properties to the material.

Second, the modified LFR exhibits excellent flame-retardant performance, evenly distributing throughout the PU foam to improve its flame resistance while maintaining the foam thermal conductivity. The LOI of the modified foam reaches 26.4%, compared to 20.0% for unmodified PU foam. The introduction of phosphorus further contributes to enhanced fire resistance by forming a protective carbon layer during combustion.

Third, the invention provides good processing adaptability and moisture stability. Unlike traditional flame retardants such as DOPO, which are hydrophilic, the modified LFR is hydrophobic, with a contact angle of at least 120°, addressing moisture-related issues. Additionally, it does not affect the foam's density (44 kg/m³) or thermal conductivity (0.024 W/(m·K)), ensuring that the PU foam retains its valuable application characteristics.

Lastly, the invention offers a cost-effective solution. Lignin, being abundant and low-cost, significantly reduces the cost of the flame retardant compared to pure DOPO-based flame retardants, making the technology more economically viable.

The invention also relates to a process for making a modified hydrophobic lignin with in-built fire retardant functional groups. The present method does not require the use of acids, solvents, or any halogenated chemicals. The process comprises heating a lignin source with a traditional fire retardant with reactive function groups (e.g. DOPO) and methylene diphenyl MDI for a reaction using a simple fabrication process with (no acid, no solvent, halogen-free) environmental-friendly steps.

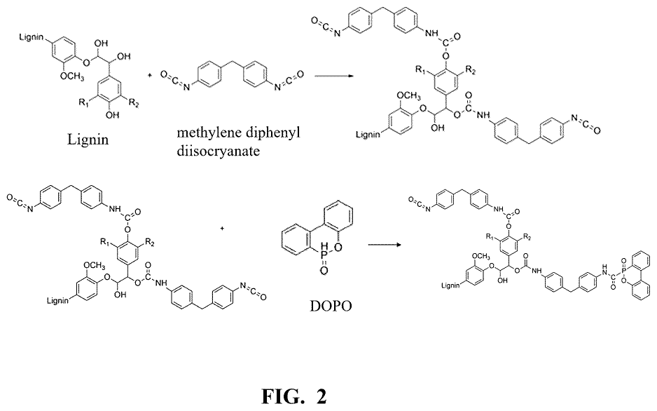

FIG. 2 shows fabrication process of the LFR. This process uses lignin as the primary material. The process involves reacting the active hydroxyl groups on lignin with MDI to produce carbamate groups. Simultaneously, by leveraging the high reactivity of the P—H group within the structure of DOPO, a potent phosphorus ester fire retardant intermediate, it is made to react with unsaturated groups. To ensure complete lignin reactivity and eliminate the need for organic solvents, the method initiates with the reaction of lignin with an excess of isocyanates under controlled heating. Subsequently, under an elevated temperature, DOPO is introduced to react with unsaturated groups. Finally, the LFR was produced.

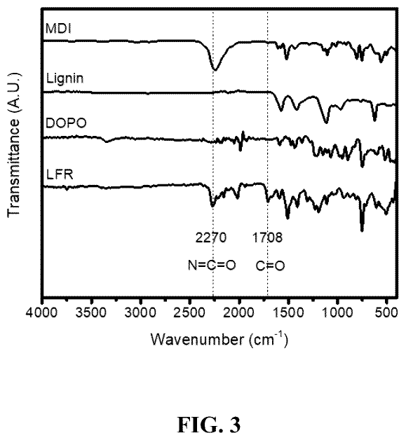

FIG. 3 shows FTIR spectroscopy of the fabricated LFR and the raw materials. The results confirm the successful synthesis of a phosphorus-enriched LFR with the formation of two typical chemical structures (—N═C═O and C═O functional groups) in LFR.

The invention also includes PU rigid foams formed through the reaction of polyester polyol, modified hydrophobic lignin with built-in fire-retardant functional groups, fire retardant fillers, catalysts, a blowing agent, and isocyanates. This PU foam inherently possesses fire retardancy and overcomes the moisture absorption issues commonly associated with traditional solid fire retardants.

The LFR preserves lignin's inherent benzene ring structure, enhancing the mechanical properties of PU materials.

The surplus isocyanate reacts with polyols, integrating the fire retardant's active groups into the PU's cross-linking network, thereby achieving inbuilt fire retardancy and mitigating dispersion and long-term migration concerns of conventional fire-retardant additive.

With carbamate structure, the LFR enhances the compatibility between the fire-retardant additive and the PU matrix, imparting the hydrophobicity with a contact angle of at least 120° from the original hydrophilic lignin with a contact angle of 27°, thereby warding off moisture absorption and agglomeration issues during storage.

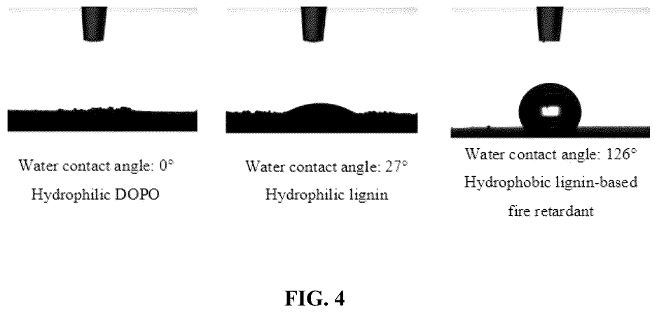

In one embodiment, using the LFR achieves a contact angle of 126°. FIG. 4 shows water contact angle of hydrophilic DOPO, hydrophilic lignin and hydrophobic LFR.

Additionally, the modified lignin improves the thermal conductivity of the PU rigid foam without affecting its density. Furthermore, this process introduces a bio-based component, increasing the bio-based content of the PU rigid foam.

Table 1 shows the density, LOI, and thermal conductivity (W/(m·K) of the PU rigid foams without fire-retardants, with the unmodified lignin, with DOPO and with the LFR.

TABLE 1

| | Blank | | | |
|---|---|---|---|---|
| | PU rigid | PU rigid | PU | PU |
| | foam | foam | rigid | rigid |
| | without | with the | foam | foam |
| | fire | unmodified | with | with |
| | retardant | lignin | DOPO | LFR |
| Density(kg · m⁻³) | 44 | 48 | 50 | 44 |
| LOI (%) | 20.0 | 26.2 | 26.4 | 26.4 |
| Thermal | 0.024 | 0.028 | 0.027 | 0.024 |
| conductivity | | | | |
| (W/(m · K) | | | | |

### EXAMPLE

### Example 1—Synthesis of LFR

Initially, 6 g of dried lignin and 50 g of isocyanates (MDI-50) undergo a controlled reaction at a specified temperature of 90° C. for a duration of 30 to 90 minutes under nitrogen gas conditions. Subsequently, the temperature is raised, and 21.6 g of DOPO is introduced into the reaction system at a specific temperature of 120-130° C. The mixture is then stirred for 15 minutes, resulting in a solid product. This product becomes crispy after 15 hours of drying and curing at an elevated temperature (>70° C.). Ball milling is then applied to further crush the solid products, and the LFR is obtained. After repeated couple of times, most of the crushed powder passes the sieve mesh #200 (74 μm).

### Example 2—Fabrication of PU Rigid Foams

Mix 100 parts of polyols, including 25 parts of non-bio-based polyols and 75 parts of bio-based polyols, with 10 parts of the LFR produced in Example 1, at room temperature. The mixture is agitated at a speed of 2000-5000 rpm. Following this, 0.9-1.4 parts of amine catalyst, 2.5 parts of foam stabilizer, 20-30 parts of fire retardant fillers, and 3-5 parts of blowing agent are added to achieve a uniform blend. Further, incorporating 150 parts of isocyanates into the mixture, thorough stirring at 23-25° C., molding for foaming, and post-curing at 60-80° C. result in the production of fire-retardant enhanced biobased PU rigid foam upon demolding.

In comparison, PU rigid foam without fire retardants, PU rigid foam with 10 parts of the unmodified lignin, PU rigid foam with 10 parts of DOPO are fabricated and their components are listed in Table 2. And their physical properties are shown in Table 1.

TABLE 2
Components of PU rigid foams without fire-retardants,
with the unmodified lignin, with DOPO and with the LFR

| | | | | | | Fire | | | |
|---|---|---|---|---|---|---|---|---|---|
| | | Foam | | | | retardant | | Blowing | |
| Note | Polyol | stabilizer | LFR | Lignin | DOPO | fillers | Catalysts | agent | Isocyanate |
| P-1 | 100 | 2.5 | — | — | — | — | 0.9-1.4 | 3 | 150 |
| (without fire | | | | | | | | | |
| retardant) | | | | | | | | | |
| P-2 (with | 100 | 2.5 | — | 10 | — | 20~30 | 0.9-1.4 | 3 | 150 |
| unmodified | | | | | | | | | |
| lignin) | | | | | | | | | |
| P-3 (with | 100 | 2.5 | — | — | 10 | 20~30 | 0.9-1.4 | 3 | 150 |
| DOPO) | | | | | | | | | |
| Example | 100 | 2.5 | 10 | — | — | 20~30 | 0.9-1.4 | 3 | 150 |
| PU with | | | | | | | | | |
| LFR | | | | | | | | | |

### Example 3—Cost Evaluation of LFR from Lignin, MDI and DOPO

Since the LFR is derived from the reaction of lignin, MDI, and DOPO, the cost of the lignin-based flame retardant is significantly reduced due to the much lower price of lignin and MDI compared to DOPO. Table 3 shows the cost evaluation of LFR from lignin, MDI and DOPO. The results show that the price of LFR in this invention is about 40% cheaper than DOPO.

TABLE 3

| | | | | Modified |
|---|---|---|---|---|
| | Lignin | DOPO | Isocyanates | lignin |
| Proportions | 7.7% | 27.8% | 64.5% | 100% |
| Cost/kg (RMB) | 2 | 160 | 78 | 95 |

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

### Definition

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of +10%, +5%, +1%, or +0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

1. A hydrophobic lignin-based in-built fire retardant, comprising:
a lignin source;
an isocyanate component; and
a phosphorous source,
wherein the lignin source is modified by reacting with the isocyanate component prior to reaction with the phosphorous source, forming a stable cross-linked network, and
wherein the hydrophobic lignin-based in-built fire retardant comprises in-built fire-retardant functional groups chemically bonded to the lignin source and exhibits a hydrophobic surface with a water contact angle greater than 120 degrees.

2. The hydrophobic lignin-based in-built fire retardant of claim 1, wherein the lignin source comprises lignosulfonic acid sodium salt, lignosulfonic acid calcium salt, or alkali lignin.

3. The hydrophobic lignin-based in-built fire retardant of claim 1, wherein the isocyanate component comprises polymethylene polyphenyl polyisocyanate, diphenylmethane diisocyanate, or a combination thereof.

4. The hydrophobic lignin-based in-built fire retardant of claim 1, wherein the phosphorous source comprises 9,10-dihydro-9-oxa-10-phosphaphenanthrene-10-oxide (DOPO).

5. The hydrophobic lignin-based in-built fire retardant of claim 1, wherein the fire retardant is in powder form, having a homogeneous particle size distribution of less than 0.074 mm.

6. The hydrophobic lignin-based in-built fire retardant of claim 1, wherein the in-built fire-retardant functional groups contribute to a limiting oxygen index (LOI) of at least 26.4% without varying the foam thermal conductivity when incorporated into the polyurethane foams.

7. The hydrophobic lignin-based in-built fire retardant of claim 1, wherein the hydrophobic lignin-based in-built fire retardant prevents water absorption, thereby maintaining thermal insulation and fire resistance performance of the hydrophobic lignin-based in-built fire retardant over time.

8. The hydrophobic lignin-based in-built fire retardant of claim 1, wherein the hydrophobic lignin-based in-built fire retardant is free from the use of acids, solvents, or halogens.

9. A method of preparing a hydrophobic lignin-based in-built fire retardant, comprising:
reacting a lignin source with an isocyanate component in a reaction system at a temperature of approximately 90° C. for 30 to 90 minutes under nitrogen gas conditions;
adding a phosphorous source into the reaction system and raising the temperature to approximately 120° C. and stirring for 10 to 20 minutes to form a solid product;
drying the solid product at a temperature greater than 70° C. for 15 hours; and
crushing the solid product into a powder and sieving it to obtain a homogeneous particle size distribution of less than 0.074 mm,
wherein the method is conducted in the absence of acids, solvents, and halogens.

10. The method of claim 9, wherein the lignin source comprises lignosulfonic acid sodium salt, lignosulfonic acid calcium salt, or alkali lignin; the isocyanate component comprises polyaryl polymethylene isocyanate or diphenyl methane diisocyanate; and the phosphorous source comprises 9,10-dihydro-9-oxa-10-phosphaphenanthrene-10-oxide (DOPO).

11. The method of claim 9, wherein the lignin source is grafted with isocyanate groups from diphenylmethane diisocyanate and non-halogenated phosphate groups from a traditional fire retardant, incorporating reactive functional groups, thereby converting original hydrophilic properties of the traditional fire retardant into hydrophobic properties.

12. A polyurethane rigid foam with in-built fire retardancy, wherein the polyurethane rigid foam comprises a formulation of:
10-90 parts of bio-based polyol;
10-90 parts of non bio-based polyol;
3 parts of blowing agent;
2-3 parts of foam stabilizer;
0.5-3 parts of catalyst;
0.1-30 parts of fire retardant fillers;
1-10 parts of hydrophobic lignin-based in-built fire retardant of claim 1; and
130-160 parts of isocyanate component;
wherein the polyurethane rigid foam has enhanced fire resistance, and
wherein the polyurethane rigid foam exhibits a hydrophobic surface with a water contact angle greater than 120 degrees.

13. The polyurethane rigid foam of claim 12, wherein the bio-based polyol is selected from bio-based polyol derived from cashew nut shell oil comprising FX9001, FX9001LV, and FX9011, or caster polyol; and the non bio-based polyol is selected from polyether polyols comprising polyether 403, polyether 4110, polyether 330N.

14. The polyurethane rigid foam of claim 12, wherein the catalyst comprises amine catalyst, comprising N,N-dicyclohexylmethylamine or triethylenediamine, and dibutyltin dilaurate.

15. The polyurethane rigid foam of claim 12, wherein the blowing agent comprises water.

16. The polyurethane rigid foam of claim 12, wherein the isocyanate component comprises polymethylene polyphenyl polyisocyanate, diphenylmethane diisocyanate, or a combination thereof.

17. The polyurethane rigid foam of claim 12, wherein the foam stabilizer comprises silicone surfactant, polyether polydimethylsiloxane copolymer, organosilicone copolymer.

18. The polyurethane rigid foam of claim 12, wherein the fire retardant fillers comprise expanded graphite, and dimethyl methylphosphonate.

19. The polyurethane rigid foam of claim 12, wherein the polyurethane rigid foam exhibits a limiting oxygen index (LOI) of at least 26.4%.

20. The polyurethane rigid foam of claim 12, wherein the polyurethane rigid foam exhibits a closed-cell structure with a cell size distribution ranging from 50 to 500 microns.
